(19) United States
(12) Patent Application Publication
(10) Pub. No.: US 2005/0252929 A1
(43) Pub. Date: Nov. 17, 2005

(54) Display cap for beverage dispenser

(75) Inventor: Gregg Bond, Beverly Hills, CA (US)

Correspondence Address: LEWIS ANTEN;Lewis Anten, Esq., A Professional Corporation, 16830 Ventura Boulevard, Suite 310, Encino, CA, 91436, US

(73) Assignee: The Helman Group, Ltd.

(21) Appl. No.: 11/127,924

(22) Filed: May 12, 2005

Related U.S. Application Data
(60) Provisional application No. 60/521,527, filed on May 13, 2004.

(51) Int. Cl. B67D 5/06

(52) U.S. Cl. 222/23

(57) ABSTRACT

A cap having a rotatable lid for use as part of a beverage dispenser is disclosed. The rotatable lid has a viewing window so that one of a plurality of beverage types listed on a nameplate dial within the lid can be viewed through the window.

This is a regular patent application based on U.S. Provisional Patent Application No. 60/521,527 filed on May 13, 2004.

### BACKGROUND OF THE INVENTION

The present invention relates to carafes and other types of hand-held beverage dispensers for use in the home, on picnics, at restaurants, etc.

Prior art beverage dispensers come in various designs and are called such terms as pitchers or carafes. For example, a carafe can be made with an insulating means such as a vacuum liner made of double glass or of some other material. Use of insulating material is a primary reason why carafes are popular for dispensing both hot and cold beverages.

Many individuals attempt to identify the contents within a beverage dispenser, particularly ones not having a see-through body, by either affixing printed labels to the outside surface of the dispenser body or by applying a piece of masking tape to said outside surface and writing the name of the beverage. These identifying attempts are first, not very aesthetic, and secondly, require to be changed at least as often as when the dispenser is used for different beverages.

### BRIEF SUMMARY OF THE INVENTION

The invention pertains to a cap or cover which can be made for use on any hand-held liquid beverage dispenser. The cap can be designed to be aesthetically pleasing, easily cleaned and functional. For descriptive purposes, the cap is presented along with a carafe-type beverage dispenser having a hollow body and a neck portion for containing liquids and a cap for engaging the inner wall of the neck portion.

Depending upon the type of beverage dispenser, the cap portion can be manufactured to include a threaded base adapted for engagement with the female threads located at the neck of a typical carafe base.

As another example, rather than having a threaded base, the cover can be manufactured with a thumb trigger so that contents can be poured from the dispenser only after the trigger is pressed, displacing the cover away from the dispenser opening in a hinge-like manner.

The novel feature of the cap is a rotatable top portion. Specifically, the cap comprises a base, a rotatable top portion having an aperture or window, and multiple indicia disposed about the top surface of the base between the base and top portion.

The indicia can be disposed upon the top surface by any of the well known methods in the art such as stamping, silk screening, adhesive or lamination.

The indicia is arranged in a circular pattern. Along different portions of the circumference on the nameplate can be written various designations such as: “Coffee”, “Tea”, “Decaf”, “Water”, “Lemonade”, etc.

The aperture or window is sized so that only a limited portion of the base top surface is viewable and that only one indicia is viewable at a time. The aperture can be configured to have a see-through plastic layer or it can be simply an open area.

The rotatable top portion can be incrementally rotated until the desired beverage designation appears through the aperture. Preferably, the cap is designed so that a slight frictional resistance maintains the desired position of the aperture relative to the indicia. Designing the cap with a slight frictional resistance is well known in the art and will not be discussed in detail herein.

In this way, a dispenser body can be filled with a beverage and the base portion of the cap or cover is positioned in the top opening such as for example, the neck of the carafe body. However, the top portion of the cover can be rotated until the beverage designation appears through the aperture. Rotation of the top portion of the cover does not change the base portion's position relative to the dispenser body.

By having a cap which can display through its window a designation referencing the contents within the beverage dispenser, individuals then do not have to guess as to what beverage is inside. This can be particularly beneficial at restaurants, picnics or other large gatherings where multiple dispensers are used each containing a different beverage.

### BRIEF DESCRIPTION OF THE DRAWINGS

FIG. 1 is a perspective view of a beverage dispenser, namely a carafe body and cap.

FIG. 2 is a top view of the cap.

FIG. 3 is a view of the cap taken along line 3-3 of FIG. 2.

### DETAILED DESCRIPTION OF THE INVENTION

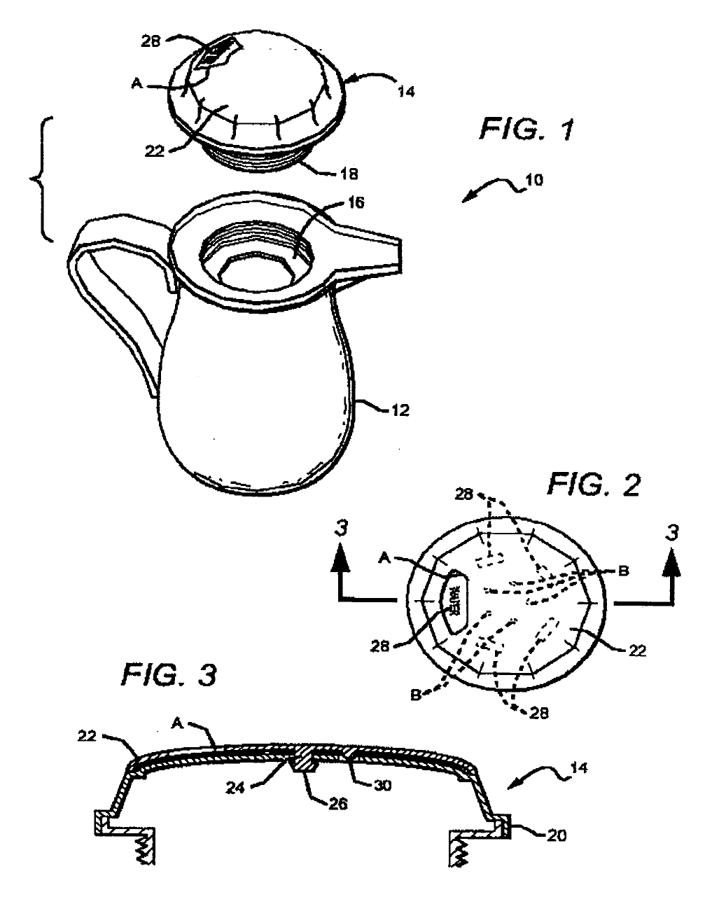

FIG. 1 illustrates beverage dispenser 10 as a carafe comprising hollow body 12 and cap 14. Cap 14 is capable of being threadably engaged to the neck portion 16 of body 12 by threads 18.

Cap 14 comprises a base 20 and top 22 which is rotatable relative to base 20. Base 20 consists of a lower portion having threads 18 and an upper portion. The lower and upper portions are made separately and then bonded together to form base 20.

Referring to FIG. 3, top 22 has a stem 24 which extends past an aperture in base 20 and has a tapered headed end 26. Initially, headed end 26 is forced through the aperture and this then prevented from being removed by the taper shape although top 22 is now able to be move about the axis created by stem 24 in its fixed relation to base 20.

Top 22 has an aperture A which is covered by see-through plastic. On the top surface of base 20 is disposed a plurality of indicia 28. Each indicia is a different designation and as illustrated in FIG. 3, the indicia viewable through aperture A is “water”. The other indicia 28 identified by hidden lines can be used to describe other beverages such as “coffee”, “decafe”, “hot water”, etc.

As can best be seen in FIG. 2, for each indicia 28 present on the top surface of base 20, there is a corresponding indentation or aperture B. Head 30 is located on the bottom side of top 22, facing the top surface of base 20 and is positioned for contact with any of indentations B.

With the parts of carafe 10 now identified, the carafe is used as follows.

A beverage is selected and poured into hollow body 12. The base 20 of cap 14 is rotated so that threads 18 threadably engage neck portion 16. With cap 14 attached to base 20, top 22 is rotated until the desired indicia that designates the beverage contained by carafe 10 is viewable through aperture A. When an indicia is fully viewable through aperture A, head 30 partially extends into indentation B, fixing the position of top 22 relative to base 20. A minor amount of rotating force is required to dislodge head 30 from its position with indentation B, thus allowing top 22 to rotate when desired. Although specific embodiments of the invention have been described in detail, the invention is not limited to the illustrated embodiments and various modifications and variations can be made in the display cap without departing from the spirit or scope of the invention. For example, while the figures show a top portion 22 that is rotatable relative to a base 20 where indicia 28 are provided, an alternative design may include a non-rotatable top portion and a rotatable member disposed beneath the top portion, with a window provided on the top portion and indicia provided on the rotatable member. As another alternative to the window in the illustrated embodiment, the indicia on the base 20 are present at locations exposed by the top portion, and the rotatable top portion has a marking (an indicator) that can be lined up with desired indicia by rotating the top portion. As yet another alternative, indicia are provided on the rotatable top portion, and a marking is provided on an exposed portion of the base so that desired indicia can be lined up with the marking by rotating the top portion. Other alternative designs may be possible. In summary, the invention is a cap with a first member and a second member that is rotatable relative to the first member, with a plurality of indicia provided on one of the first and second members and an indicator (such as a window, a marking, or other suitable indicators that can indicate the desired indicia when aligned with it) provided on the other one of the first and second members.

1. A carafe comprising:
a hollow body having an upward extending neck portion; and
a cap removably attached to said neck portion, said cap including:
a first member;
a second member rotatable relative to the first member;
a plurality of indicia provided on one of the first and second members; and
an indicator provided on the other one of the first and second members.

2. The carafe of claim 1, wherein the first member forms a base of the cap having a top surface, wherein the plurality of indicia are provided on the top surface, and wherein the second member is a top portion rotatably connected to the base.

3. The carafe of claim 2, wherein the top portion defines a window for viewing a portion of the top surface of the base.

4. The carafe of claim 1, wherein the second member is disposed above the first member, wherein the first member has a top surface, wherein the plurality of indicia are provided on the top surface, and wherein the second member defines a window for viewing a portion of the top surface.

5. A cap for use with a carafe, the cap comprising:
a first member;
a second member rotatable relative to the first member;
a plurality of indicia provided on one of the first and second members; and
an indicator provided on the other one of the first and second members.

6. The cap of claim 5, wherein the first member forms a base of the cap having a top surface, wherein the plurality of indicia are provided on the top surface, and wherein the second member is a top portion rotatably connected to the base.

7. The cap of claim 6, wherein the top portion defines a window for viewing a portion of the top surface of the base.

8. The cap of claim 5, wherein the second member is disposed above the first member, wherein the first member has a top surface, wherein the plurality of indicia are provided on the top surface, and wherein the second member defines a window for viewing a portion of the top surface.
